(19) United States
(12) Patent Application Publication
(10) Pub. No.: US 2001/0033049 A1
(43) Pub. Date: Oct. 25, 2001

(54) Inspection plate for die storage packs

(76) Inventor: Paul Gurule, Maplewood, MN (US)

Correspondence Address: John M. Vasuta, VP & General Counsel, AUGUST TECHNOLOGY, 4900 West 78th Street, Bloomington, MN, 55435, US

(21) Appl. No.: 09/841,623

(22) Filed: Apr. 24, 2001

Related U.S. Application Data
(60) Provisional application No. 60/199,687, filed on Apr. 24, 2000.

(51) Int. Cl. B23Q 3/00

(52) U.S. Cl. 269/53

(57) ABSTRACT

A tray or plate designed and configured to hold unique size and shaped storage receptacles for processed wafers such as die in gel or waffle packs as used in the semiconductor industry during the manufacturing and inspection processing so that it is securely held during this processing. The tray including a plurality of pins and a spring loaded corner jig that holds the storage receptacle securely against the pins.

### BACKGROUND OF THE INVENTION

1. Technical Field

The present invention relates to a tray or plate for use with manufacturing and inspection equipment where the tray is designed and configured to hold unique size and shaped processed wafer storage packs or containerized processed wafers, such as die in gel or waffle packs, and the like as used in the semiconductor industry during the manufacturing and inspection processing so that it is securely held during this processing.

2. Background Information

Over the past several decades, the semiconductor has exponentially grown in use and popularity. The semiconductor has in effect revolutionized society by introducing computers, electronic advances, and generally revolutionizing many previously difficult, expensive and/or time consuming mechanical processes into simplistic and quick electronic processes. This boom in semiconductors has been fueled by an insatiable desire by business and individuals for computers and electronics, and more particularly, faster, more advanced computers and electronics whether it be on an assembly line, on test equipment in a lab, on the personal computer at one's desk, or in the home electronics and toys.

The manufacturers of semiconductors have made vast improvements in end product quality, speed and performance as well as in manufacturing process quality, speed and performance. However, there continues to be demand for faster, more reliable and higher performing semiconductors.

One process that has evolved over the past decade or so is the semiconductor inspection process. The merit in inspecting semiconductors throughout the manufacturing process is obvious in that bad wafers may be removed at the various steps rather than processed to completion only to find out a defect exists either by end inspection or by failure during use. The saved time and expense is significant if a bad substrate can be removed prior to further processing or installation into an end product.

A typical example of the semiconductor manufacture process is summarized as follows. Bare whole wafers are manufactured. Thereafter, circuitry is created on the bare whole wafers. The whole wafer with circuitry is then sawn into smaller pieces known in the industry as die. Thereafter, the die are processed, as is well known in the art, typically as die in waffle and/or gel packs or on substrates.

In the waffle pack or gel pack area, these packs are uniquely shaped and sized to house the delicate die therein. As a result, automated processing is difficult because of the difficulty associated with grabbing and securely holding the waffle pack. Since automation is key to the growth of semiconductor inspection as well as manufacturing, and it is necessary to rapidly, accurately and securely move the waffle pack or other substrate holder, a solution is needed to allow for the automated processing of these waffle packs with die therein as well as other similar substrate holders such as die in gel packs, sawn wafers such as on film frames, JEDEC trays, Auer boats, multi-chip modules often referred to as MCMs, etc. Often, such movement and positioning within the manufacturing or inspection equipment is done manually which is time consuming, expensive, and inaccurate.

### SUMMARY OF THE INVENTION

In the area of semiconductor wafers, it is well known that such wafers once sawn into individual dies are stored in waffle or gel packs or the like, hereinafter referred to as die storage packs. The present invention is a storage or handling tray or plate that allows for rapid attachment of the die storage packs, that is waffle or gel packs, thereto while also providing a secure and accurate attachment of the die storage packs via the tray or plate to the inspection or manufacturing equipment.

### BRIEF DESCRIPTION OF THE DRAWINGS

Preferred embodiment of the invention, illustrative of the best mode in which applicant has contemplated applying the principles, are set forth in the following description and are shown in the drawings and are particularly and distinctly pointed out and set forth in the appended claims.

Image 1 is a top view of one embodiment of a die storage pack tray removed from and set next to one embodiment of an attachment plate that the tray securely sets on to attach to an inspection system;

Image 2 is an enlarged view of the die storage pack tray of Image 1;

Image 3 is a further enlarged and fragmentary view of one seat on the die storage pack tray of Images 1 and 2;

Image 4 is a perspective view of a portion of the die storage pack tray of Images 1-3 showing at least one entire seat;

Image 5 is an enlarged view of the securing mechanism for use with each seat on the die storage pack tray; and

Image 6 is an enlarged view of one embodiment of an attachment plate usable with the die storage pack tray.

Similar numerals refer to similar parts throughout the drawings.

### DESCRIPTION OF THE PREFERRED EMBODIMENT

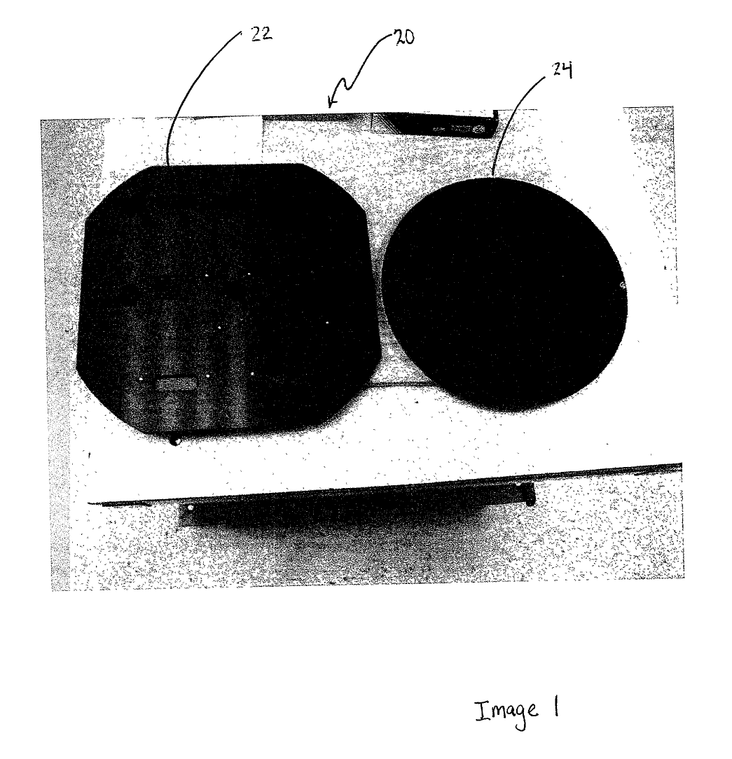

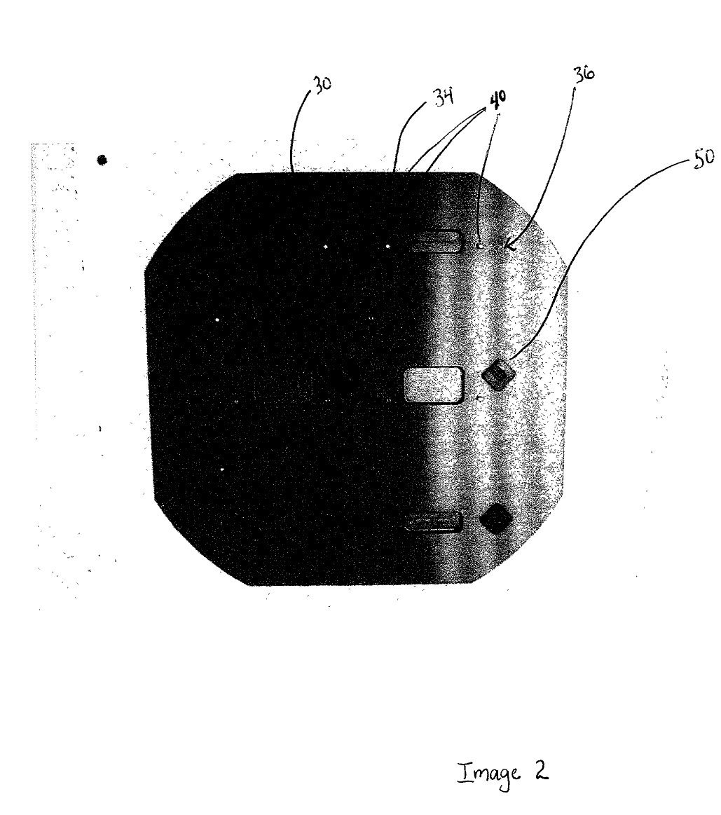

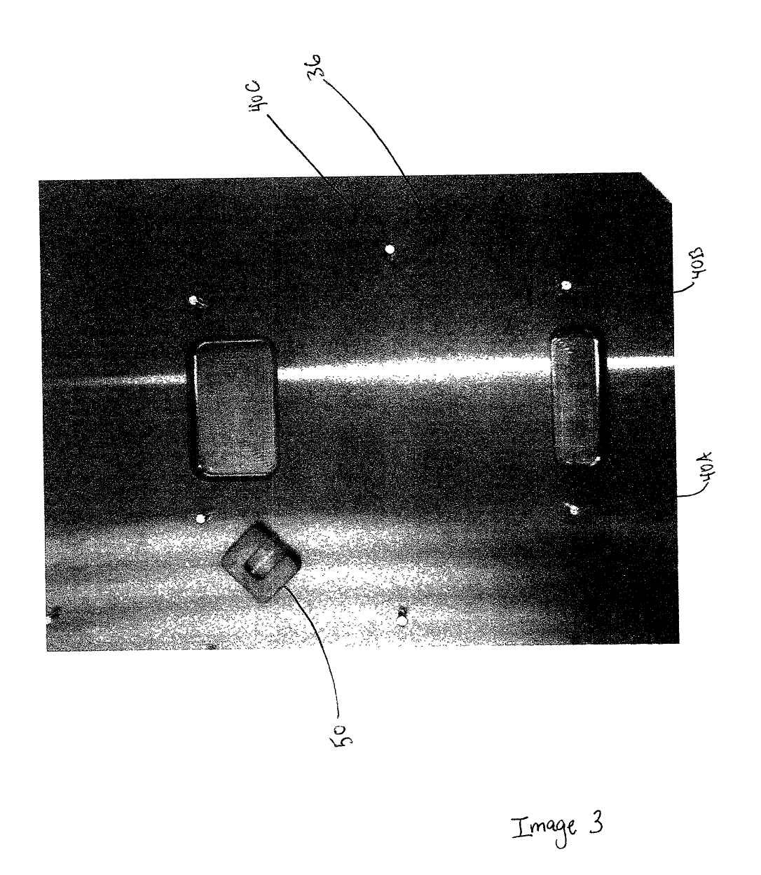

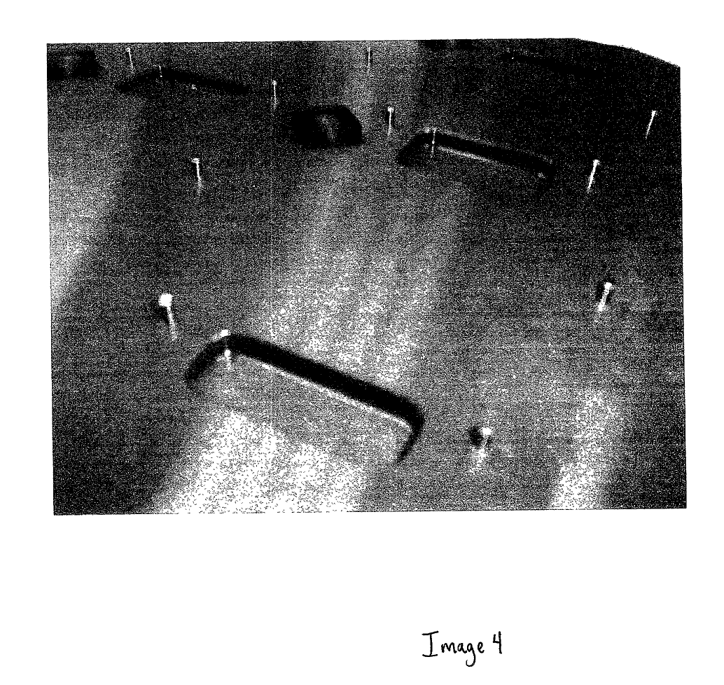

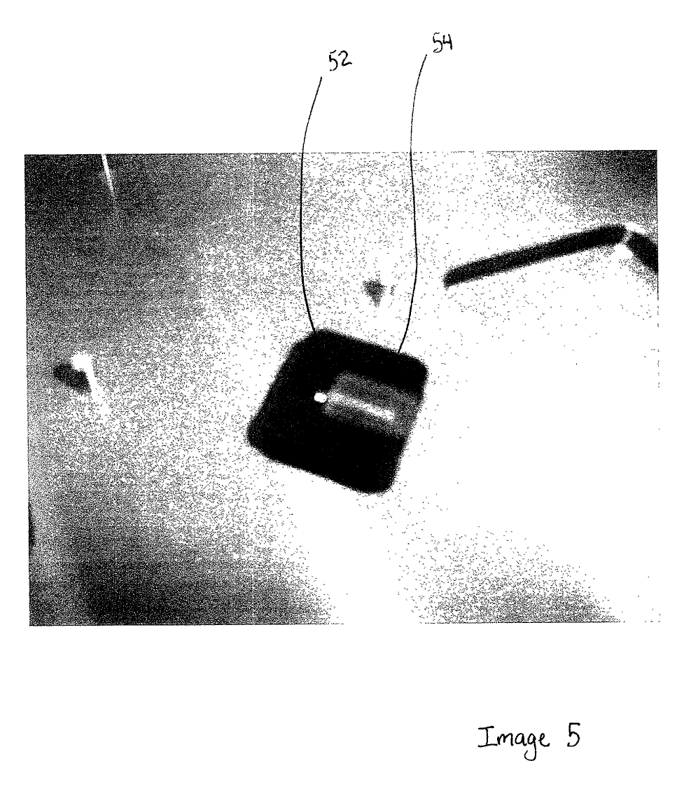

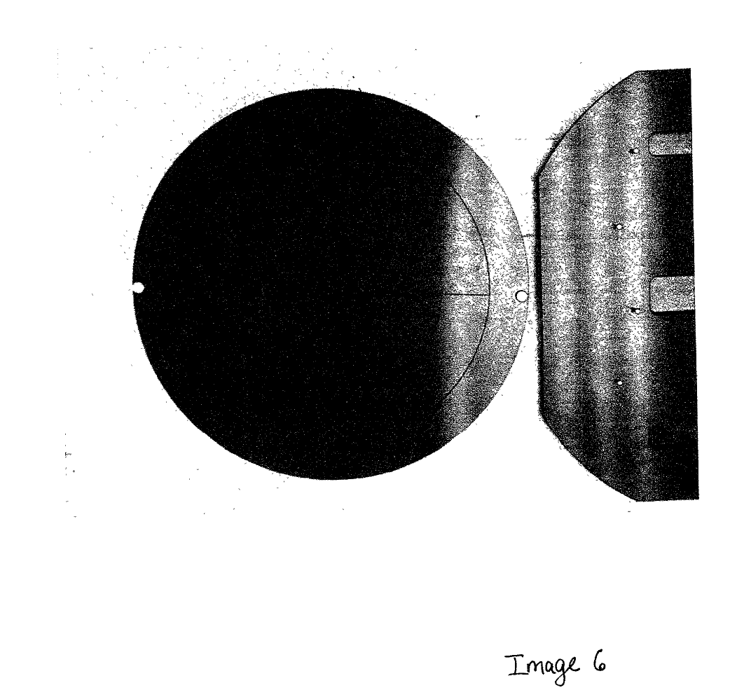

The die storage pack tray system of the present invention is indicated generally at 20 and includes a die storage pack tray 22 as is best shown overall in FIGS. 1 and 2 and is used in one environment to receive one or more waffle or gel or like packs and securely hold them on an inspection system or the like, such as one described in U.S. patent application Ser. No. 09/352,564 filed Jul. 13, 1999. It is noted that in some embodiments, this system 20 also includes an attachment plate 24 that allows for rapid, exact and secure positioning of the tray 22 onto an inspection system, as well as providing a generic plate that allows for quick changing of the type of die storage tray when it is desirable to inspect different size die or a different type of substrate. It is further noted that in other embodiments where a plate 24 is not present, the features of the plate 24 are incorporated into the bottom side of the tray 22. It is even further noted that the concept as described herein is equally applicable and contemplated to be used for other wafers, whether yet processed or not, that are stored in some form of a storage or carrier devices, or any device or structure approximating the size and shape of such packs as described above that may be retained for inspection.

The die storage pack tray 22, in a first embodiment as is shown in the Figures, includes a top planar surface 30, a bottom surface 32, and a plurality of short sides 34 connecting the surfaces 30 and 32. In this embodiment, the top planar surface 30 includes four die storage pack (waffle or gel pack) holding systems, each system being generally indicated by the numeral 36. It is contemplated that any number of die storage pack holding systems could be positioned on the plate including four die storage pack holding systems as is shown for holding 4″ waffle or gel packs for instance, or even sixteen die storage pack holding systems for holding 2″ waffle or gel packs. Alternatively, should it become desirable to have waffle or gel packs in sizes bigger than the current 4″, then one large system for holding one pack larger than 4″ is contemplated, or should it become desirable to have waffle or gel packs that are of a 3″ nature, then a tray having for instance nine die storage pack holding systems is contemplated, and similarly, should it become desirable to have waffle or gel packs that are of a size smaller than 2″ in nature, then a tray having for instance twenty five die storage pack holding systems is contemplated. It is in essence contemplated that any square or rectangular device, or any other polygonal shape, with a 45° corner or similar structure could be securely retained and/or held by this invention.

Each die storage pack holding system 36 includes a plurality of fixed pegs or pins 40 in between which the die storage pack is pinned during use. In this embodiment, the number of pins 40 is three as is shown in the Figures. These three pins are carefully positioned in this embodiment such that one end of the die storage pack is forced against pins 40A and 40B, while an adjacent side of the die storage pack is forced against pin 40C, whereby these three fixed stops allow the die storage pack to be secured thereagainst and prohibit rocking or turning of the die storage pack on the planar surface 30.

Each die storage pack holding system 36 also includes a corner jig 50 that forces the die storage pack against the plurality of pins 40A, 40B and 40C and thereby securely holds the die storage pack on the planar surface 30 of tray 22. Corner jig 50 includes a C-shaped body 52 with a spring loaded finger 54. The corner jig is positioned at an angle to correspond to the tapered corner of a waffle or gel pack; however it is contemplated that it could be oriented in other manners to receive other types of die storage packs.

The planar top surface 30 of the tray includes at least one indentation or recess 58 therein for receiving the C-shaped body 52 and finger 54. The C-shaped body 52 has an upper surface 60 and a lower surface 62, the lower surface 62 including an attachment mechanism 64 for securely fixing the body 52 to the surface 30. In one embodiment, the attachment mechanism 64 is a pair of threaded holes alignable with holes in the recess portion of the surface through which screws or other like fasteners are threaded. The C-shaped body 52 and finger 54 are seated within the recess 58.

C-shaped body 52 also includes a slot 66 having a pair of opposing faces 68 and 70 and an end face 72 with an optional bore 74. The slot 66 is of a first width along the upper surface 60 and a second width along the lower surface 62 where the second width is smaller than the first width. In one embodiment, the slot faces from the upper surface 60 to the lower surface 62 are smooth transitions defining an angled, tapered or chamfered surface such that an overall dovetailed arrangement is defined. In a second embodiment, the slot faces are stepped or gib-style instead.

The spring loaded finger 54 includes a pair of sides 80 and 82 that are configured in a slidable mating arrangement with faces 68 and 70, that is in a dove tailed, gib-style or stepped arrangement that mates with faces 68 and 70. Basically, each side 80 and 82 of the finger 54 has a wing 84 that slidably fits in between the tapered surface or stepped surface of faces 68 or 70 and the top surface 30. The finger thus slides within the slot 66 within the dove tailed, gib-style or stepped arrangement, or any other configuration that would allow for axial movement within the slot while prohibiting removal of the finger from the slot in any other direction including removal in the direction of the upper surface. The finger 54 is also restricted from sliding out of the dove tailed, gib-style or stepped arrangement or other arrangement because of the partial seating of the body 52 and finger 54 in the recess 58 such that a stop or lip 88 is defined to stop the finger from further outward movement.

The spring loaded finger 54 includes a spring 90 within a bore 92 in the finger. The spring 90 extends from the bore 92 and rests against end face 72. In the optional embodiment where bore 74 exists in end face 72, the spring is seated therein. The spring 90 biases the finger away from the end face 72 and against the lip 88.

The end of the finger 54 that engages lip 88 may also include a slight taper or chamfer to allow for easier insertion of a die storage tray such as a waffle pack or gel pack therein. The finger 54 is typically retracted and the die storage pack inserted in between the pins 40A, 40B and 40C and the retracted finger. In this case where the corner jig 50 is angled, the angled corner of the die storage pack must also be properly positioned adjacent thereto. Once the die storage pack is positioned, the finger 54 is released thereby securing it therein. Alternatively, the die storage pack may be used to forcibly retract the finger while the die storage pack is positioned in between the pins.

The top surface of the finger 54 may also include a ridge or other projections, or a groove or other indentations that allows the user to engage the finger and forcibly retract it.

The surface 30 also may include removal recesses 100 that are positioned to allow a user to lift a die storage pack therefrom once the finger 54 is retracted by force placed thereon.

In one embodiment, the bottom surface 32 of the tray 22 includes a pair of holes 120 for alignment and securing reasons. These holes 120 are configured, positioned, sized and shaped to correspond to a pair of guide pins that extend out from a top surface 130 in the base plate or attachment plate 24. When the base plate 24 is secured to an inspection or manufacturing system, the tray 22 may be rapidly aligned and set thereon in a stable manner.

The base plate 24 may also be provided with suction via vacuum holes therein to provide additional holding of the tray to the plate.

The above description and embodiment has been focused on die that are stored in waffle or gel packs. It is however contemplated that this invention may be used with any processed wafer or the like that is stored in any square or rectangular device with at least on angled corner, such as a 45° angle, that can be securely held and retained in between the plurality of pins and the corner jig.

It is further contemplated that should new storage containers be designed for any type of wafer or processed wafer that need to be held firmly with at least one wafer or processed wafer therein, and more likely many individual pieces that once were a wafer before processing such as sawing, that this invention would apply to such storage containers.

Accordingly, the invention as described above and understood by one of skill in the art is simplified, provides an effective, safe, inexpensive, and efficient device, system and process which achieves all the enumerated objectives, provides for eliminating difficulties encountered with prior devices, systems and processes, and solves problems and obtains new results in the art.

In the foregoing description, certain terms have been used for brevity, clearness and understanding; but no unnecessary limitations are to be implied therefrom beyond the requirement of the prior art, because such terms are used for descriptive purposes and are intended to be broadly construed.

Moreover, the invention's description and illustration is by way of example, and the invention's scope is not limited to the exact details shown or described.

Having now described the features, discoveries and principles of the invention, the manner in which it is constructed and used, the characteristics of the construction, and the advantageous, new and useful results obtained; the new and useful structures, devices, elements, arrangements, parts and combinations, are set forth in the appended claims.

We claim:

1. A tray designed and configured to hold unique size and shaped storage receptacles for processed wafers such as die as stored in waffle or gel packs as used in the semiconductor industry during the manufacturing and inspection processing so that it is securely held during this processing, the tray comprising:
a die storage receptacle receiving surface;
a plurality of pins extending therefrom; and
a jig attached to the surface for holding a die storage receptacle against the plurality of pins.

2. The tray of claim 1 wherein the plurality of pins are fixed pegs positioned such that a die storage pack having a plurality of sides is forced against at least one peg on one of the plurality of sides and against at least another one of the pegs on another one of the plurality of sides whereby these pegs when used in conjunction with the jig allow the die storage pack to be secured thereagainst and prohibit rocking or turning of the die storage pack on die storage receptacle receiving surface.

3. The tray of claim 1 wherein the jig further comprises a body with a spring loaded finger.

4. The tray of claim 3 wherein the body has an upper surface and a lower surface, whereby the lower surface including an attachment mechanism for securely fixing the body to the die storage receptacle receiving surface.

5. The tray of claim 4 wherein the die storage receptacle receiving surface includes at least one recess therein in which the body and finger are seated.

6. The tray of claim 3 wherein the jig is positioned at an angle to correspond to the tapered corner of any one of a waffle and gel pack.

7. The tray of claim 3 wherein the body includes a slot having a pair of opposing faces and an end face, and wherein the slot is of a first width along the upper surface and a second width along the lower surface where the second width is smaller than the first width.

8. The tray of claim 7 wherein the slot faces from the upper surface to the lower surface are of a dovetailed arrangement.

9. The tray of claim 7 wherein the slot faces from the upper surface to the lower surface are of a stepped arrangement.

10. The tray of claim 7 wherein the spring-loaded finger includes a pair of sides that are configured in a slidable mating arrangement with slot faces.

11. The tray of claim 10 wherein each side of the finger includes a wing that slidably fits in slot such that the finger slides within the slot.

12. The tray of claim 1 wherein the finger includes a slight taper to allow for easier insertion of a die storage tray such as a waffle pack or gel pack therein.

13. A method of removably securing unique size and shaped storage receptacles for processed wafers such as die as stored in waffle or gel packs as used in the semiconductor industry during the manufacturing and inspection processing so that it is securely held during this processing to a plate for use in inspection and other like processing steps, the method comprising:
pushing a corner portion of a die storage receptacle against an outwardly extended spring-loaded finger thereby overcoming the spring bias where the finger is slidably connected within a jig attached to a die storage receptacle receiving surface on a die storage plate;
tipping the die storage receptacle such that one of its faces engages the die storage receptacle receiving surface on the die storage plate; and
allowing the spring bias in the finger to secure the die storage receptacle against a plurality of pins extending from the die storage receptacle receiving surface on the die storage plate thereby holding the die storage receptacle securely and accurately in a preferred position for inspection or other processing steps.

14. The method of claim 13 further comprising the steps of:
pushing the corner portion of the die storage receptacle against the outwardly extended spring-loaded finger thereby overcoming the spring bias; and
tipping the die storage receptacle such that the face engaging the die storage receptacle receiving surface on the die storage plate disengages therefrom and the die storage receptacle is removable from the die storage plate.
